(19) United States
(12) Patent Application Publication
(10) Pub. No.: US 2025/0078674 A1
(43) Pub. Date: Mar. 6, 2025

(54) METHOD AND SYSTEM FOR FACILITATING COMPLIANCE WITH STUDY PROTOCOL

(71) Applicant: Crest Trials, Inc., Sunnyvale, CA (US)

(72) Inventors: Yasir Sepha, Menlo Park, CA (US); Mauro Campigotto, Camposampiero, CA (US)

(21) Appl. No.: 18/817,724

(22) Filed: Aug. 28, 2024

Related U.S. Application Data
(60) Provisional application No. 63/534,917, filed on Aug. 28, 2023.

(51) Int. Cl. G09B 5/02; G01J 1/42

(52) U.S. Cl. CPC G09B 5/02; G01J 1/4204

(57) ABSTRACT

A handheld system for the objective measurement of compliance with a clinical study protocol, such as an ETDRS BCVA study protocol. The system and methods use a handheld device application and associated sensors of the device to measure ambient light, and the distances between objects in an examination lane to determine compliance. The system may also identify objects in the room and provide an interface for users to understand compliance and receive training.

### CROSS REFERENCE TO RELATED APPLICATION(S)

This patent application claims priority to a co-pending U.S. Provisional Patent Application Ser. No. 63/534,917 filed Aug. 28, 2023 entitled “Method and System for Improving Medication Compliance”, the entire contents of which are hereby incorporated by reference.

### BACKGROUND

The most widely accepted functional endpoint which is accepted by the FDA for drug approval in Ophthalmology is the Early Treatment Diabetic Retinopathy Study Best-Corrected Visual Acuity (ETDRS BCVA). One of the most significant problems in ensuring standardization across multiple sites across the globe is the certification of BCVA examiners and the configuration of the exam lanes at each site—in other words, certification officers travel to the sites to ensure the site has the necessary tools and trained examiners to be able to assess patients' vision consistently according to the study protocol. This drives the cost of initiating the sites, and eventually the study, significantly higher and slows the activation of the sites which amounts to valuable time lost.

Additionally, different certification officers may have different approaches to certification which can potentially introduce bias in the study findings. Healthcare systems recognize the problem of variability and logistics. Therefore, it would be highly desirable to have an application which assess the requirements at the site using a standardized approach and allow for training using a ubiquitous course material.

### SUMMARY

This patent application is generally directed to systems and methods for the objective assessment of lane requirements for an ETDRS BCVA exam and the expertise of the examiner at the site. In some embodiments, a system utilizes the features of a handheld device such as a smart phone or tablet, including object and/or character recognition using pictures captured using a camera, ambient light intensity measurement using the light sensor of the handheld device, and length/distance measurements using lidar, also typically accessible via the handheld device when possible.

A user interface of an application running on the handheld device is divided in two workflows for determining compliance with a study protocol, and thus for certification of the exam lane and examiner. Certification of the exam lane requires the end user to collect information about the examination room and the availability of the required tools. The application can also geotag the collected information, measure distance and ambient light. Furthermore, the user can schedule a meeting using Microsoft Teams (or similar meeting platform) to evaluate the submitted material with a BCVA Certification Officer. Once all the requirements are met, the room can be certified as being in compliance with the protocol. The application also provides custom training material to train the site personnel and assess the level of their understanding. The application evaluates the examiner knowledge by a dedicated quiz. Also in thi case, the examiner can schedule a meeting using Microsoft Teams (or similar meeting platform) to evaluate his/her knowledge supported by a BCVA Certification Officer.

In some embodiments, the system is a device that can fulfil all the requirements of a certification process without the need for human resource.

In some configurations, the mobile application may interact with another system such as a networked server, a cloud service, or other data processing systems.

Methods executed by the system generally also involve having a central tangible computer readable medium or processing unit that communicates over a network to a system operated by the certification body if the site and personnel meet the requirement of ETDRS BCVA certification.

### BRIEF DESCRIPTION OF THE DRAWINGS

The description below refers to the accompanying drawings, of which:

FIG. 1 is a Login Page;

FIG. 2 is an Examiner Request Landing Page;

FIG. 3 is an Examiner Actions Screen;

FIG. 4 is a BCVA Guide Screen;

FIG. 5 is a Training Video Screen:

FIG. 6 is an Examiner Quiz View;

FIG. 7 is an Examiner Meeting Schedule;

FIG. 8 is a Lane Request Landing Page;

FIG. 9 is an Lane Actions Screen;

FIG. 10 is an example of Equipment List Page;

FIG. 11 is an example of Equipment Information View;

FIG. 12 is an example of Distance Measurement;

FIG. 13 is an example of Light Measurement;

FIG. 14 is a Lane Meeting Schedule; and

FIG. 15 illustrates an example environment where the mobile application is being used to assess lane requirements.

FIG. 16 is an example of the process flow.

### DETAILED DESCRIPTION OF PREFERRED EMBODIMENTS

The embodiments of the present invention are directed towards methods and systems for collection of information about the settings of an exam lane and assess the competencies of examiners. The embodiments may include: a handheld device with a mobile application installed, auditory and visual stimuli to guide a user through the process of the certification, and which provides an ability for certification officers to communicate and/or observe the certification process to aid in standardization or otherwise determining compliance with a protocol. The system may also include a handheld device which can provide a training course and/or collect information regarding the equipment available at the site for use in an ETDRS BCVA—compliant exam room.

The mobile application utilizes some of the inherent functionality of a handheld device such as a smartphone or tablet.

For example, device sensors such as the ambient light sensor used to control screen brightness may be used to detect changes in the light intensity of the room. The device camera and GPS may be used to capture geotagged images from the environment to ensure all the required tools for BCVA measurement are present at the site. The captured images may be processed through an object recognition system which can identify the required tools in the picture. A lidar enabled embodiment of the device can be used to measure the distance from an examination chair to the ETDRS chart to ensure the chart is placed at the adequate (e.g., 4m or 1m) distance.

The mobile application may also host training material and courses which can guide the examiners and personnel at the site on how to perform the examination according to the protocol The training material may be provided in the form of a video, reading material, and/or slides.

A description of an example implementation of the mobile application follows.

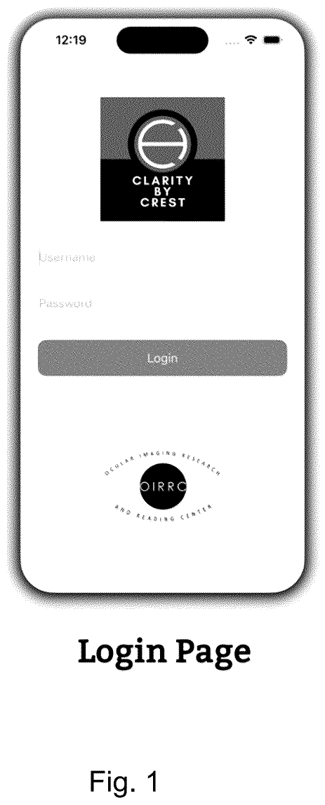

FIG. 1 is an example Login Page. The login page permits to safely access the App only for approved users.

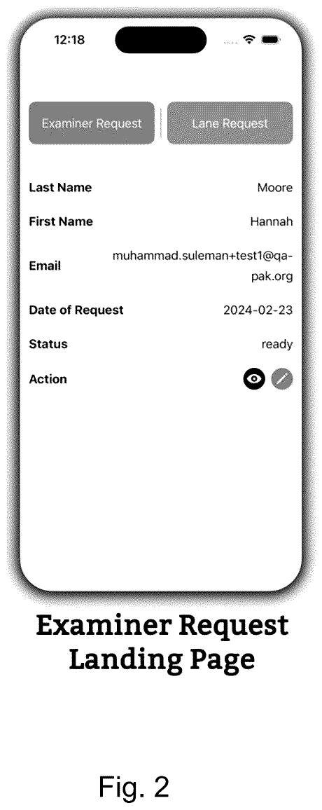

FIG. 2 is an example Examiner Request Landing Page. The Examiner Request Landing page permits the review of the main information related to a BCVA Examiner certification request.

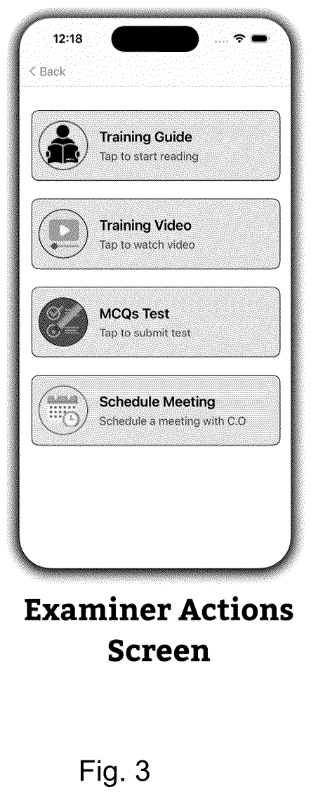

FIG. 3 is an example Examiner Actions Screen. The Examiner Actions Screen permits access to the main steps requested to accomplish the BCVA Examiner Certification request.

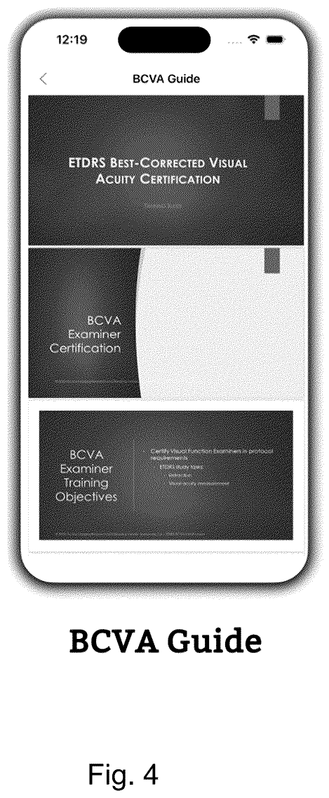

FIG. 4 is an example screen for viewing a BCVA Guide. Upon pressing the “Training Guide” button at the top of the screen, users have access to the BCVA Training Manual, which they can read through. After that, they can then press the “I Have Understood This Guide” button at the bottom of the page, which sends a variable to the database confirming that the guide has been read.

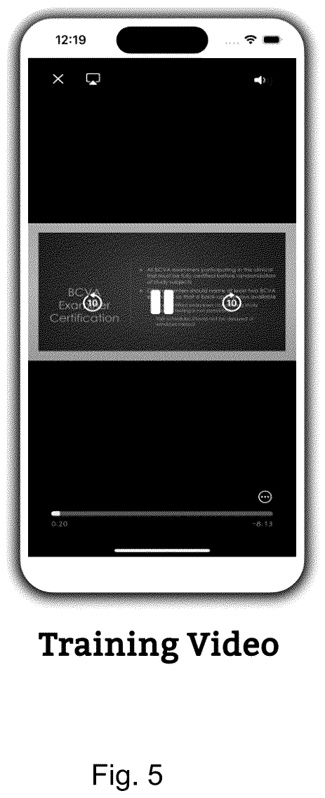

FIG. 5 is an example screen for viewing a Training Video. When the “Training Video” button is pressed, an video is played. When the video has been watched, a variable is sent to the database confirming it on that end. Subsequent watches can be skipped and rewound.

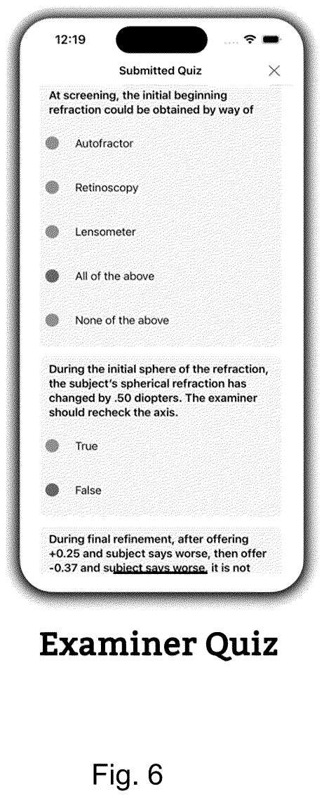

FIG. 6 is an example screen for an Examiner Quiz View. Opened using the “MCQ Test” button, this view brings up multiple quiz questions. When all the answers are selected and the finish button is pressed, the answers are graded, results are shown to the user, and the number of correct answers is sent to the database.

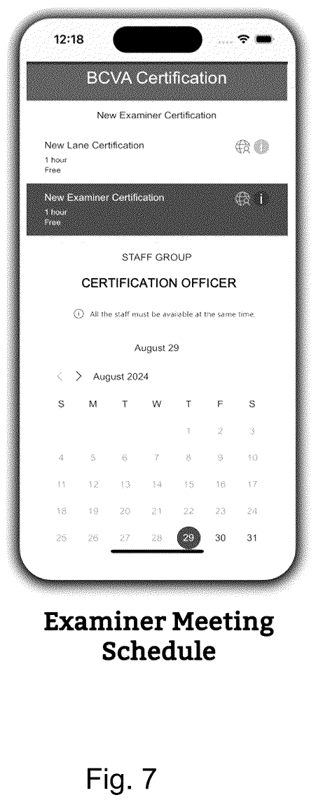

FIG. 7 is an example of Examiner Meeting Schedule screen. Selecting the ‘Schedule Meeting’ button, a dedicated panel will appear offering to the Examiner the possibility to schedule a meeting with a Certification Officer to review the submitted material and further evaluate the certification request.

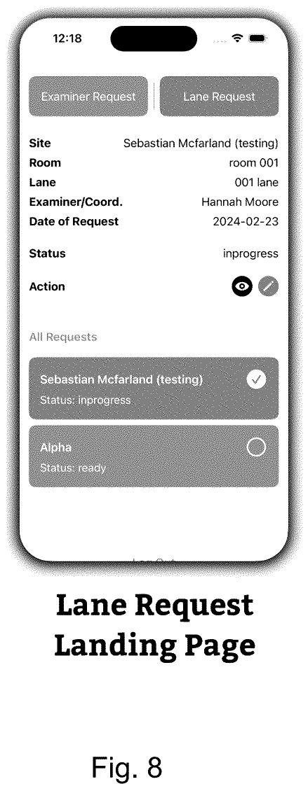

FIG. 8 is an example of Lane Request Landing page. The Lane Request Landing page permits to review the main information related to a BCVA Lane Certification request.

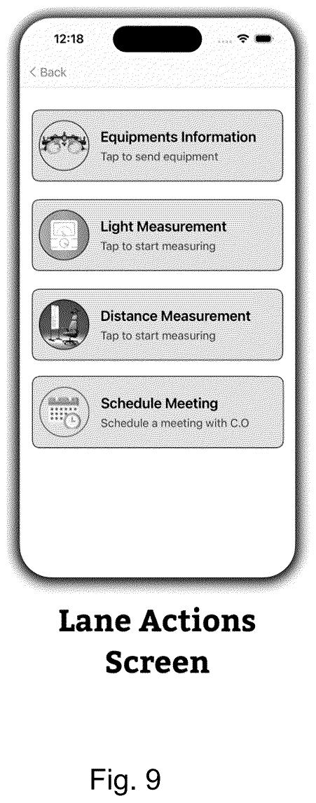

FIG. 9 is an example of Lane Actions Screen. The Lane Actions Screen permits access to the main steps requested to accomplish the BCVA Lane Certification request.

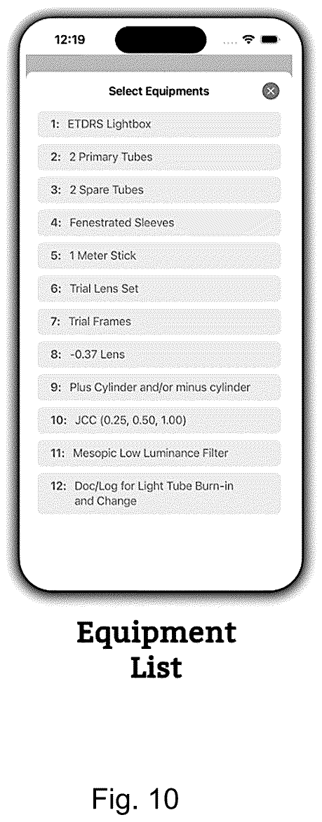

FIG. 10 is an example Equipment List page. The Equipment List page show the list of Equipment needs to be submitted with the related information.

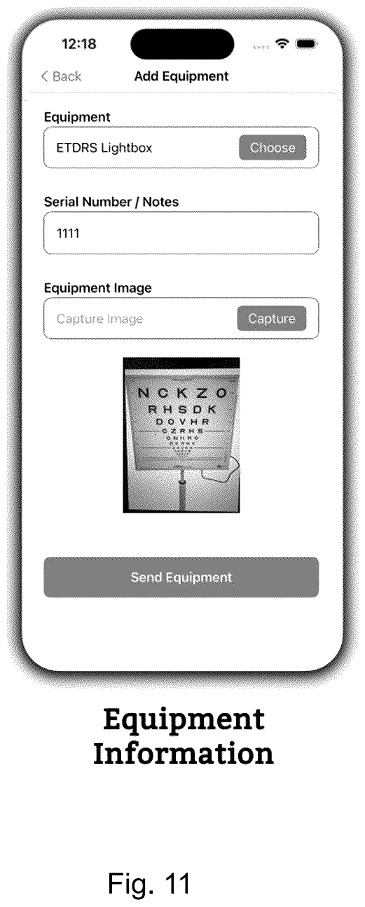

FIG. 11 is an example of Equipment Information page permits the selection of equipment including Serial Number or Notes, acquiring a live picture, and submitting it to the database, including geotag data.

This view consists of 3 value fields:
The ‘Equipment’ field at the top opens a dropdown sheet with different BCVA tools when pressed.
The ‘Serial Number/Notes’ text field allows users to manually enter the Serial Numbers listed on their equipment for inventory or Notes about the selected equipment.
The ‘Equipment Image’ field allows users to select live image of the selected equipment, including geotagging information.

After all fields have been filled, the ‘Send Equipment’ button can be pressed to send all of these values to the database.

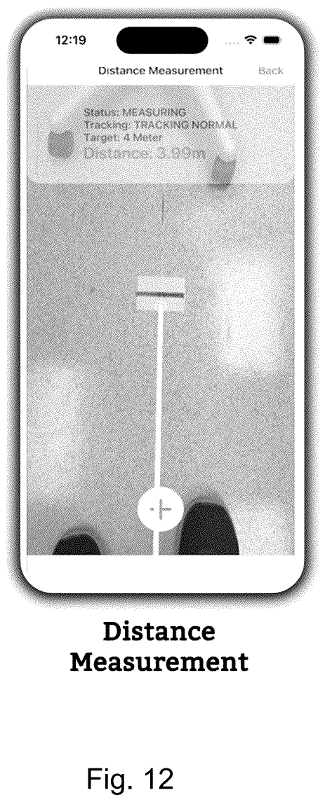

FIG. 12 is an example of Distance Measurement. The distance measurement (for example, 1m or 4m) is used to keep distance between patient seat and vision chart, by using lidar to make precise to make precise measurement using the app view. The target distance is selected in the action sheet and displayed in the HUD at the top. When the plus button is pressed, the measurement starts. As the measuring takes place, the Distance gauge in the HUD adjusts to the length of the line being drawn in AR. When the button is pressed a second time, the measurement stops, and the line remains in the view in AR. A new button appears at the bottom right of the view, which, when pressed, sends the Target and Distance values to the database. It is also possible to manually insert the measurement, including a live image of the room.

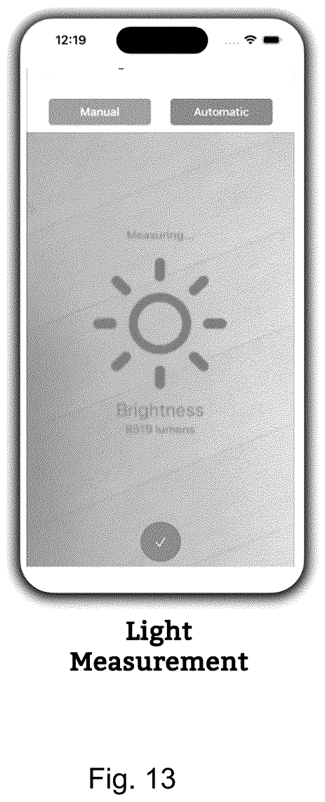

FIG. 13 is an example of Light Measurement. This view uses raw camera data from the phone's rear camera to estimate the light levels of its surroundings in lumens (lux). This variable constantly updates under the sun icon, and is sent to the database when the blue tick button at the bottom of the view is pressed. It is also possible to manually insert the measurement, including a live image of the room.

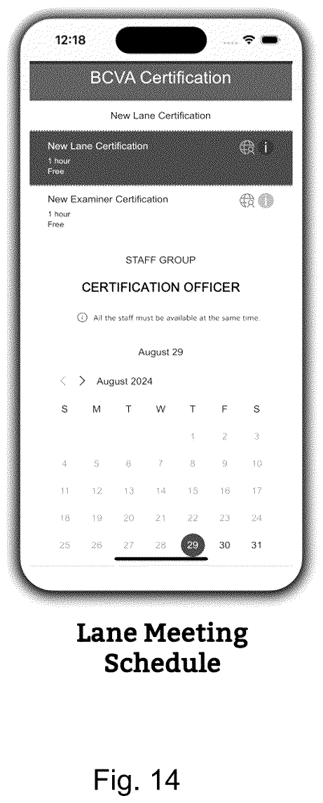

FIG. 14 is an example Lane Meeting Schedule. Selecting the ‘Schedule Meeting’ button, a dedicated panel will appear offering to the Study coordinator the possibility to schedule a meeting with a Certification Officer to review the submitted material and further evaluate the certification request.

As has been discussed already, certain eye care professionals conducting clinical research are required to have a dedicated ETDRS exam lane with proper lighting and equipment, and are required to be ETDRS-certified as an examiner. Personnel and equipment must be certified to test at specified distances, such as at four meters and one meter.

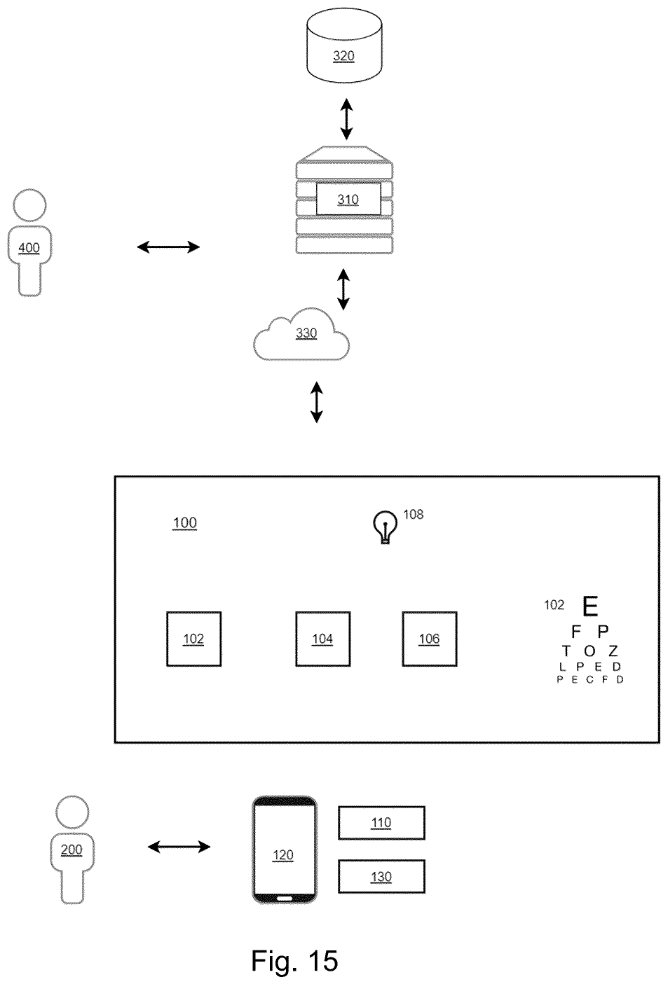

FIG. 15 illustrates a typical exam lane site 100 include a chair 102, one or more ETDRS eye charts 104, eye examination equipment 106, and ambient light source(s) 108. The certification application 110 as described above is running on a mobile handheld device 120, such as a smartphone or tablet. Personnel 200 use the handheld device 120 to interact with one or more servers 310, and/or databases 320 such as via a internet or other network connection 330. The servers 310 and databases 320 may be provided by a cloud service such as Amazon AWS or Microsoft Azure.

Sensors in device 120, such as an ambient light sensor used to control screen brightness may be used by the application to detect changes in the light intensity of the exam lane 100. The camera of device 120 may be used by personnel 200 to capture and geotag images from the environment. These images may include photos of the eye charts 104, equipment 106, other tools, or other conditions or aspects of the room 100. The use of the certification application 110 ensures all the required equipement and tools for BCVA measurement are present at the site. The captured images may be processed through an object recognition component 130 which can identify the required tools in the picture. Object recognition 130 may operate on the device 120 or on one of the servers 310.

A lidar enabled embodiment of the device 120 can be used to measure the distance from examination chair 102 to the ETDRS chart 104 to ensure the chart is placed at the adequate (e.g., 1m and/or 4m) distances.

As explained previously, the same mobile application 110 may also host training material and courses which can guide the examiners and personnel at the site on how to perform the examination according to the protocol. The training material may be provided in the form of a video, reading material, and/or slides.

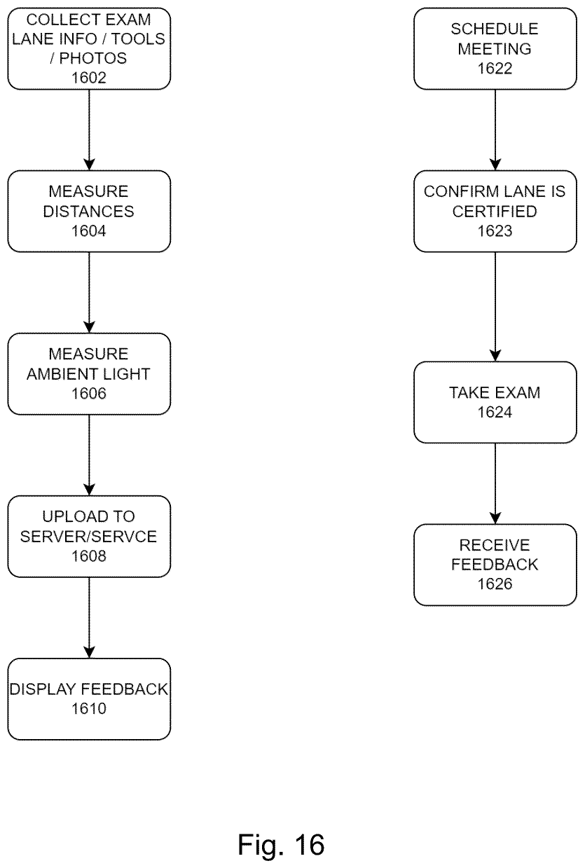

FIG. 16 are example workflows for certification of the exam lane and eye examiner personnel. In a first step 1602 towards certification that the exam lane is in compliance with the protocol, an end user operates the application 110 to collect information about the examination room 100 and the availability of the required tools 106. The application can also geotag the collected information using a GPS within the handheld device. In step 1604, the application measures distances and in step 1606 measures ambient light. This data is then uploaded in 1608 and made available to a BCVA Certification Officer 400 such as via the server(s)/service 310. Feedback from the officer 400 may then be displayed at step 1610.

Furthermore, eye exam personnel seeking cerification can also use the application 110 to schedule a meeting 1622 using Microsoft Teams (or similar meeting platform) to evaluate the submitted material with the BCVA Certification Officer 400. Once all the requirements are met, the room and personnel can be certified at 1623. The application also provides a platform for custom training material to train the site personnel and assess the level of their understanding. The application can for example evaluates the user's knowledge by a dedicated exam in step 1624. Also in this case, the user can receive feedback at step 1626 on the exam results provided by the BCVA Certification Officer.

### Implementation Options

It should be understood that the example embodiments described above are not intended to be exhaustive or limited to the precise form disclosed, and thus may be implemented in many different ways. In some instances, the various “handheld devices”, “smartphones”, “phones”, “tablets” and other types of “data processing platforms” may each be implemented by a separate or shared physical general purpose computer, or virtual or cloud-implemented general-purpose computer, each having or having access to a central processor, memory, disk or other mass storage, communication interface(s), input/output (I/O) device(s), and other peripherals. The general-purpose computer is transformed into the processors and executes the processes described above, for example, by loading software instructions into the processor, and then causing execution of the instructions to providing one or more computing platforms that carry out the functions described.

As is known in the art, such a computer may contain a system bus, where a bus is a set of hardware lines used for data transfer among the components of a computer or processing system. The bus or busses are shared conduit(s) that connect different elements of the computer system (e.g., processor, disk storage, memory, input/output ports, network ports, etc.) that enables the transfer of information between the elements. One or more central processor units are attached to the system bus and provide for the execution of computer instructions. Also attached to system bus are typically device interfaces for connecting various input and output devices (e.g., keyboard, mouse, touchscreen, displays, speakers, etc.) to the computer. Network interface(s) allow the computer to connect to various other devices attached to a network. Memory provides volatile or non-volatile storage for computer software instructions and data used to implement an embodiment. Disk including magnetic or solid state disks or other mass storage devices provide non-volatile, non-transitory storage for computer software instructions and data used to implement, for example, the various procedures described herein.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc. It also should be understood that the block, flow, network and code diagrams and listings may include more or fewer elements, be arranged differently, or be represented differently.

Other modifications and variations are possible in light of the above teachings. For example, while a series of steps has been described above with respect to the flow diagrams, the order of the steps may be modified in other implementations. In addition, the steps, operations, and steps may be performed by additional or other modules or entities, which may be combined or separated to form other modules or entities. For example, while a series of steps has been described with regard to certain figures, the order of the steps may be modified in other implementations consistent with the principles of the invention. Further, non-dependent steps may be performed in parallel. Further, disclosed implementations may not be limited to any specific combination of hardware.

Certain portions may be implemented as “logic” that performs one or more functions. This logic may include hardware, such as hardwired logic, an application-specific integrated circuit, a field programmable gate array, a microprocessor, software, wetware, or a combination of hardware and software. Some or all of the logic may be stored in one or more tangible non-transitory computer-readable storage media and may include computer-executable instructions that may be executed by a computer or data processing system. The computer-executable instructions may include instructions that implement one or more embodiments described herein. The tangible non-transitory computer-readable storage media may be volatile or non-volatile and may include, for example, flash memories, solid state disks, dynamic memories, removable disks, and non-removable disks.

Also, the term “user”, as used herein, is intended to be broadly interpreted to include, for example, a computer or data processing system or a human user of a computer or data processing system, unless otherwise stated.

The above description has particularly shown and described example embodiments. However, it will be understood by those skilled in the art that various changes in form and details may be made therein without departing from the legal scope of this patent as encompassed by the appended claims.

What is claimed is:

1. A system for facilitating compliance with an ETDRS BCVA study protocol, the system comprising:
a mobile handheld device, configured to operate one or more sensors within the mobile handheld device for:
measuring ambient light information in an exam room located at a site; and
measuring distance information in the exam room; and
one or more data processors located within the mobile handheld device; and
one or more computer readable media comprising a mobile application consisting of instructions that, when executed by the one or more data processors, cause the
one or more data processors to:
receive data including the ambient light information and the distance information,
receive image and/or video data taken from the exam room, and
determine that required tools and other conditions are present at the site as specified by the study protocol.

2. The system as in claim 1 wherein the instructions further comprise a user interface configured to display information to a user regarding whether exam room is in compliance.

3. The system of claim 2 wherein the instructions are further to forward ambient the light information, distance information, image data and/or video data to a remote server to determine if required tools and other conditions as specified by the protocol are present.

4. The system as in claim 1 wherein the instructions are further configured to provide access to training material for the study protocol.

5. The system as in claim 1 wherein the instructions are further configured to provide feedback on how to modify tools or other conditions present at the site so that they are in compliance with the study protocol.

6. A method for facilitating compliance with a protocol for an ophthalmic clinical trial, the method Fcomcomprising:
operating sensors on a mobile handheld device for:
measuring ambient light information at a site for the clinical trial; and
measuring distance information at the site;
receiving image and/or video data taken from the site, and
determining via an automated process operating at least in part on the mobile handheld device that required tools and other conditions as specified by the protocol are present at the site.

7. The method of claim 6 further comprising:
displaying information to a user regarding whether the site is in compliance with the protocol.

8. The method of claim 7 wherein the determining step further comprises:
forwarding ambient light information, distance information, image data and/or video data to a remote server to determine if required tools and other conditions as specified by the protocol are present.

9. The method of claim 6 further comprising:
providing access via the mobile handheld device to training material for the protocol.

10. The method of claim 6 further comprising:
displaying feedback on how to modify tools or other conditions present at the site so that they are in compliance with the protocol.
